(19) United States
(12) Patent Application Publication
(10) Pub. No.: US 2012/0197644 A1
(43) Pub. Date: Aug. 2, 2012

(54) INFORMATION PROCESSING APPARATUS, INFORMATION PROCESSING METHOD, INFORMATION PROCESSING SYSTEM, AND PROGRAM

(75) Inventors: Tohru Nagano, Kanagawa-ken (JP); Masafumi Nishimura, Kanagawa-ken (JP); Ryuki Tachibana, Kanagawa-ken (JP)

(73) Assignee: International Business Machines Corporation, Armonk, NY (US)

(21) Appl. No.: 13/360,905

(22) Filed: Jan. 30, 2012

(30) Foreign Application Priority Data
Jan. 31, 2011 (JP) 2011-017986

(51) Int. Cl. G10L 15/04

(52) U.S. Cl. 704/254; 704/E15.001

(57) ABSTRACT

An information processing apparatus, information processing method, and computer readable non-transitory storage medium for analyzing words reflecting information that is not explicitly recognized verbally. An information processing method includes the steps of: extracting speech data and sound data used for recognizing phonemes included in the speech data as words; identifying a section surrounded by pauses within a speech spectrum of the speech data; performing sound analysis on the identified section to identify a word in the section; generating prosodic feature values for the words; acquiring frequencies of occurrence of the word within the speech data; calculating a degree of fluctuation within the speech data for the prosodic feature values of high frequency words where the high frequency words are any words whose frequency of occurrence meets a threshold; and determining a key phrase based on the degree of fluctuation.

### CROSS-REFERENCE TO RELATED APPLICATION

This application claims priority under 35 U.S.C. §119 from Japanese Patent Application No. 2011-017986 filed Jan. 31, 2011, the entire contents of which are incorporated herein by reference.

### BACKGROUND OF THE INVENTION

The present invention relates to a speech analysis technique. More particularly, this invention relates to an information processing apparatus, information processing method, and computer readable storage medium for analyzing words to determine information that is not explicitly recognized verbally, such as non-verbal or paralinguistic information, in speech data.

Clients and users often make a telephone call to a contact employee for receiving complaints and/or inquiries in order to make a customer comment, complaint, or inquiry about a product or service. The employee of the company or organization talks with the client or user using a telephone line to respond to his complaint or inquiry. Nowadays, conversations between utterers are recorded by a speech processing system for utilization in precise judgment or analysis of a situation at a later time. Contents of such an inquiry can also be analyzed by transcribing an audio recording into text. However, speech includes non-verbal information (such as the speaker's sex, age, and basic emotions such as sadness, anger, and joy) and paralinguistic information (e.g., mental attitudes such as suspicion and admiration) that are not included in text produced by transcription.

The ability to correctly extract information relating to the emotion and mental attitude of the utterer from his/her speech data recorded as mentioned above can improve a work process relating to a call center or enable such information to be reflected in new marketing activities among others.

Besides products and services, it is also desirable to make effective use of voice calls for purposes other than business, such as proposing a more effective suggestion or preparing proactive measures based on future prediction according to non-verbal or paralinguistic information for a person at the other end of the line by identifying his emotion in an environment where talkers do not meet face-to-face, such as in a telephone conference or consultation.

Known techniques for analyzing emotions from recorded speech data include International Publication No. 2010/041507, Japanese Patent Laid-Open No. 2004-15478, Japanese Patent Laid-Open No. 2001-215993 Japanese Patent Laid-Open No. 2001-117581, Japanese Patent Laid-Open No. 2010-217502, and Ohno et al., “Integrated Modeling of Prosodic Features and Processes of Emotional Expressions”, at http://www.gavo.t.u-tokyo.ac.jp/tokutei_pub/houkoku/model/ohno.pdf.

International Publication No. 2010/041507 describes a technique for analyzing conversational speech and automatically extracting a potion in which a certain situation in conversation in a certain context possibly occurs.

Japanese Patent Laid-Open No. 2004-15478 describes a voice communication terminal device capable of conveying non-verbal information such as emotions. The device applies character modification to character data derived from speech data in accordance with an emotion which is automatically identified from an image of the caller's face taken by an imaging unit.

Japanese Patent Laid-Open No. 2001-215993 describes interaction processing for extracting concept information for words, estimating an emotion using a pulse acquired by a physiological information input unit and a facial expression acquired by an image input unit, and generating text for output to the user in order to provide varied interaction in conformity to the user's emotion.

Japanese Patent Laid-Open No. 2001-117581 describes an emotion recognizing apparatus that performs speech recognition on collected input information approximately determines the type of emotion, and identifies a specific kind of emotion by combining results of detection, such as overlap of vocabularies and exclamations, for the purpose of emotion recognition.

Japanese Patent Laid-Open No. 2010-217502 describes an apparatus to detect the intention of an utterance. The apparatus extracts the intention of an utterance for an exclamation included in speech utterance in order to determine the intention of the utterance from information about prosodies included in the speech utterance and information on phonetic quality. Ohno et al., “Integrated Modeling of Prosodic Features and Processes of Emotional Expressions”, at URL address:http://www.gavo.t.u-tokyo.ac.jp/tokutei_pub/houkoku/model/ohno.pdf discloses formulation and modeling for relating prosodic features of speech to emotional expressions.

International Publication No. 2010/041507, Japanese Patent Laid-Open No. 2004-15478, Japanese Patent Laid-Open No. 2001-215993, Japanese Patent Laid-Open No. 2001-117581, Japanese Patent Laid-Open No. 2010-217502 and Ohno et al., “Integrated Modeling of Prosodic Features and Processes of Emotional Expressions”, at URL address:http://www.gavo.t.u-tokyo.ac.jp/tokutei_pub/houkoku/model/ohno.pdf describe techniques for estimating an emotion from speech data. The techniques described in International Publication No. 2010/041507, Japanese Patent Laid-Open No. 2004-15478, Japanese Patent Laid-Open No. 2001-215993, Japanese Patent Laid-Open No. 2001-117581, Japanese Patent Laid-Open No. 2010-217502 and Ohno et al., “Integrated Modeling of Prosodic Features and Processes of Emotional Expressions”, at URL address:http://www.gavo.t.u-tokyo.ac.jp/tokutei_pub/houkoku/model/ohno.pdf are intended to estimate an emotion using one or both of text and speech, rather than automatically detecting a word representative of an emotion in speech data or a portion of interest using verbal and sound information in combination.

### SUMMARY OF THE INVENTION

One aspect of the present invention provides an information processing apparatus for acquiring, from speech data of a recorded conversation, a key phrase identifying information that is not expressed verbally in the speech data, the apparatus including: a database including (i) the speech data of the recorded conversation and (ii) sound data used for recognizing phonemes, within the speech data, as at least one word; a sound analyzing unit configured to (i) perform sound analysis on the speech data using the sound data and (ii) assign the word to the speech data; a prosodic feature deriving unit configured to (i) identify a section surrounded by pauses within a speech spectrum of the speech data, and (ii) perform sound analysis on the identified section where (i) said sound analysis generates prosodic feature values for an identified word in the identified section and (ii) the prosodic feature values is an element of the identified word; an occurrence-frequency acquiring unit configured to acquire frequencies of occurrences of each of the words assigned by the sound analyzing unit within the speech data; and a prosodic fluctuation analyzing unit configured to calculate a degree of fluctuation within the speech data for the prosodic feature values of high frequency words, and determine a key phrase based on the degree of fluctuation where the high frequency words is any word whose frequency of occurrence meets a threshold.

Another aspect of the present invention provides an information processing method for acquiring, from speech data of a recorded conversation, a key phrase identifying information that is not expressed verbally in the speech data, the information processing method includes the steps of: extracting, from a database, speech data of the recorded conversation and sound data used for recognizing phonemes included in the speech data as words; identifying a section surrounded by pauses within a speech spectrum of the speech data; performing sound analysis on the identified section to identify a word in the section; generating prosodic feature values for the words where the prosodic feature values of the words are an element of the words; acquiring frequencies of occurrence of the word within the speech data; calculating a degree of fluctuation within the speech data for the prosodic feature value of high frequency words where the high frequency words are any words whose frequency of occurrence meets a threshold; and determining a key phrase based on the degree of fluctuation.

Another aspect of the present invention provides a computer readable storage medium tangibly embodying a computer readable program code having computer readable instructions which when implemented, cause a computer to carry out the steps of a method comprising: extracting, from a database, speech data of the recorded conversation and sound data used for recognizing phonemes included in the speech data as words; identifying a section surrounded by pauses within a speech spectrum of the speech data; performing sound analysis on the identified section to identify a word in the section; generating prosodic feature values for the words where the prosodic feature values of the words are an element of the words; acquiring frequencies of occurrence of the word within the speech data; calculating a degree of fluctuation within the speech data for the prosodic feature value of high frequency words where the high frequency words are any words whose frequency of occurrence meets a threshold; and determining a key phrase based on the degree of fluctuation.

### BRIEF DESCRIPTION OF THE DRAWINGS

FIG. 1 shows an embodiment of an information processing system 100 for performing emotion analysis according to an embodiment of the invention.

FIG. 2 shows a functional block diagram of the information processing apparatus 120 according to an embodiment of the invention.

FIG. 3 is a flowchart generally showing an information processing method for determining key phrases according to an embodiment of the invention.

FIG. 4 conceptually illustrates identification of a speech spectrum region carried out by the information processing apparatus at step S303 of the process described in FIG. 3 according to an embodiment of the invention.

FIG. 5 shows an embodiment of various lists generated at steps S304, S305 and S309 in an embodiment of the embodiment.

FIG. 6 illustrates an embodiment of a prosodic feature vector generated in an embodiment of the invention using a word “hai (“yes”)” as an example.

FIG. 7 is a flowchart generally showing a process of identifying a topic that had psychological influence on the speaker using a key phrase determined by an embodiment of the invention as an index in a speech spectrum.

FIG. 8 is a graph plotting duration of words used in calculation of degree of fluctuation with the horizontal axis representing the time of occurrence in speech data and the vertical axis representing phoneme duration by mora according to an embodiment of the invention.

FIG. 9 shows the result of temporally indexing speech data used in Example 2 with words “ee (“yes”)” and “hee (“oh”)” according to an embodiment of the invention.

FIG. 10 is an enlarged view of a box 880 region shown in FIG. 9 according to an embodiment of the invention.

### DETAILED DESCRIPTION OF THE PREFERRED EMBODIMENTS

The present invention will be described below with reference to embodiments shown in the drawings, though the invention should not be construed only with regard to the embodiments described below.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While various techniques for estimating non-verbal or paralinguistic information in words included in speech data have been known, they also use information other than verbal information, such as physiological information or facial expressions, for estimation of non-verbal or paralinguistic information, or register prosodic feature for predetermined words in association with non-verbal or paralinguistic information and estimate an emotion or the like relating to a particular registered word.

Use of physiological information or facial expression for acquiring non-verbal or paralinguistic information can complicate a system or requires a device for acquiring information other than speech data, such as physiological information or facial expressions. Also, even when words are registered in advance and prosodic feature for the words is analyzed to relate the words to non-verbal or paralinguistic information, an utterer does not always utter a registered word or can use terms or words specific to the utterer. In addition, words used for emotional expression can not be common to all instances of conversation.

Besides, recorded speech data typically has a finite time length and conversation can not be in the same context in individual time divisions over the time length. Thus, it varies also with the subject of conversation or temporal transition which portion of speech data having a finite time length includes what kind of non-verbal or paralinguistic information. Therefore, it can be possible to narrow the range of speech data analysis and hence efficiently search a particular region of speech data if a word characterizing non-verbal or paralinguistic information that gives meaning to the entire speech data or a word characterizing non-verbal or paralinguistic information that is representative of a particular time section can be acquired through direct analysis of speech data and speech data over a certain time length is indexed, instead of specifying particular words in advance.

In view of this, an object of the present invention is to provide an information processing apparatus, information processing method, information processing system, and program that enable estimation of a word reflecting non-verbal or paralinguistic information within speech data that is not explicitly expressed verbally, such as emotions or feelings in speech data recorded for a certain time length.

The present invention has been made in view of the challenges of prior art described above. The invention analyzes a word having information that is not verbally expressed, such as a mutterer's emotion and mental attitude, in speech data representing human conversations using a prosodic feature in the speech data, thereby extracting such a word as a key phrase characterizing non-verbal or paralinguistic information for the speaker in the conversation from speech data of interest.

The present invention performs sound analysis on a speech section separated by pauses within a speech spectrum included in speech data having a particular time length to derive such features as temporal length of a word or phrase, fundamental frequency, magnitude, and cepstrum. The magnitude of variations in the features over speech data is defined as a degree of fluctuation, and a word with the highest degree of fluctuation is designated as a key phrase in a particular embodiment. In another embodiment, a number of words can be designated as key phrases in descending order of the degree of fluctuation.

The designated key phrase can be used for indexing of a section that had influence on non-verbal or paralinguistic information included in the key phrase within speech data.

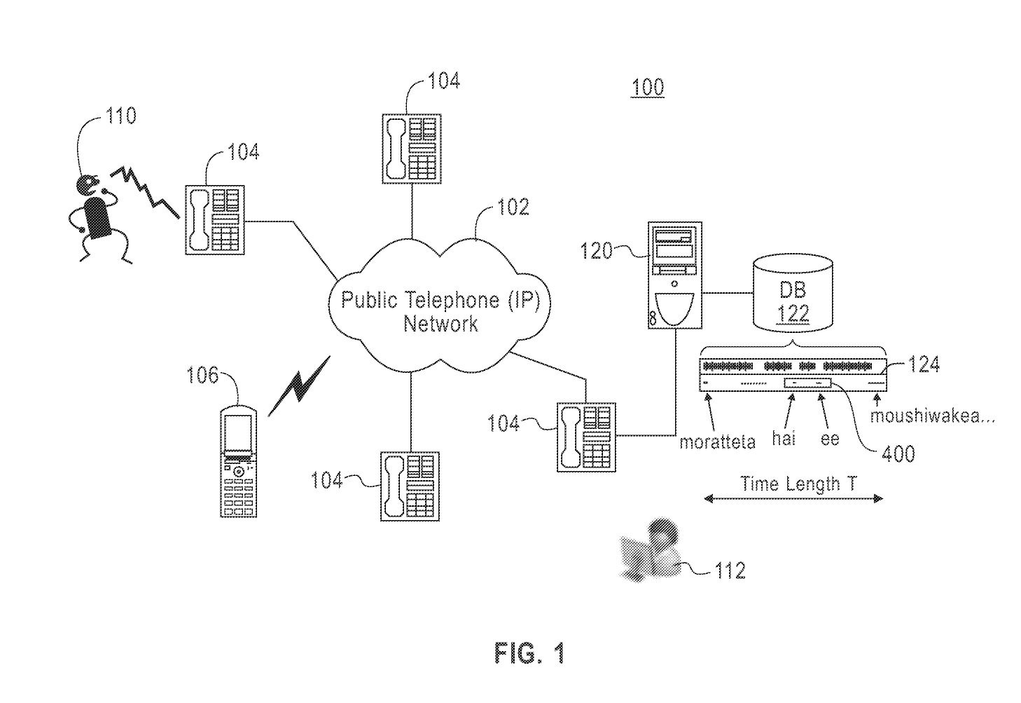

FIG. 1 shows an embodiment of an information processing system 100 for performing emotion analysis according to an embodiment of the present invention. In the information processing system 100 shown in FIG. 1, a caller makes a phone call to a company or organization via a fixed-line telephone 104 or a mobile telephone 106 connected to a public telephone network or an IP telephone network 102 and has a conversation. The embodiment shown in FIG. 1 omits illustration of a telephone exchange. When a caller 110 calls a company or organization from the fixed-line telephone 104, an employee 112 at the company or organization who is in charge of response to the caller 110 handles the call from the caller. A personal computer or the like connected with the fixed-line telephone 104 of the employee 112 records conversations held between the caller 110 and the employee 112, and sends speech data to an information processing apparatus 120, which can be a server, for example.

The information processing apparatus 120 accumulates received speech data in a database 122 or the like such that utterance sections of the caller 110 and employee 112 are identifiable and makes the data available for later analysis. The information processing apparatus 120 can be implemented within a microprocessor contained within a CISC architecture, such as PENTIUM® series, PENTIUM®-compatible chip, OPETRON®, and XEON®, or an RISC architecture such as POWERPC®, in the form of a single or multi-core processor. The information processing apparatus is controlled by an operating system such as WINDOWS® series, UNIX®, and LINUX®, executes programs implemented using a program language such as C, C++, Java®, JavaBeans®, Perl, Ruby, and Python, and analyzes speech data.

Although FIG. 1 shows that the information processing apparatus 120 accumulates and analyzes speech data, a separate information processing apparatus (not shown) for analyzing speech data can be utilized for sound analysis in other embodiments of the invention in addition to the information processing apparatus 120 to accumulate speech data. When sound analysis is conducted by a separate information processing apparatus, the information processing apparatus 120 can be implemented as a web server or the like. For distributed processing, a so-called cloud computing infrastructure can be adopted.

Speech data 124 on the recorded conversation between the caller 110 and the employee 112 can be stored in the database 122. The speech data 124 can be related to index information for identifying the speech data, e.g., date/time and name of the employee, such that speech data for the caller 110 and speech data for the employee 112 are temporally aligned with each other. In FIG. 1, the speech data is illustrated as a speech spectrum for sounds such as “ . . . moratteta (“got”)”, “hai (“yes”)”, and “ee (“yes”)”, as an example.

The present invention identifies a particular word or phrase by detecting the presence of pauses, or silent sections, that are present before and after the word or phrase in order to characterize a conversation, and extracts words for use in emotion analysis. A pause as called herein can be defined as a section in which silence is recorded for a certain length on both sides of a speech spectrum, as shown by a rectangular area 400 in the speech data 124. A pause section will be described in greater detail later.

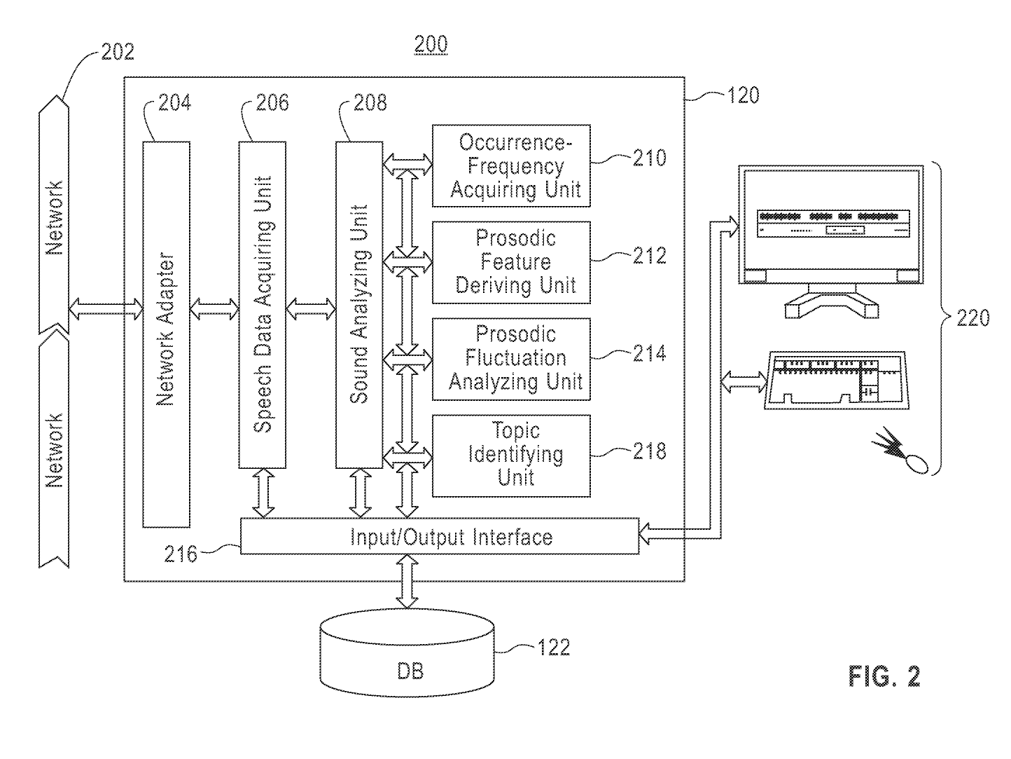

FIG. 2 shows a functional block diagram 200 of the information processing apparatus 120 according to an embodiment of the present invention. The information processing apparatus 120 acquires conversation held between the caller 110 and the employee 112 via a network 202 as speech data (a speech spectrum) and passes the data to a speech data acquiring unit 206 via a network adapter 204. The speech data acquiring unit 206 records the speech data in the database 122 via an input/output interface 216 with index data for indexing the speech data itself, making it available for subsequent processing.

A sound analyzing unit 208 performs processes including reading a speech spectrum of the speech data from the database 122, performing feature extraction on the speech spectrum to derive a MFCC (mel-frequency cepstrum coefficient) and a fundamental frequency (f0) for speech data detected in the speech spectrum, assigning a word corresponding to the speech spectrum, and converting the speech data into text. Generated text can be registered in the database 122 in association with the analyzed speech data for later analysis. To this end, the database 122 contains data for use in sound analysis, such as fundamental frequencies and MFCCs for morae of various languages such as Japanese, English, French, and Chinese, as sound data, and enables automated conversion of speech data acquired by the information processing apparatus 120 into text data. For feature extraction, any of conventional techniques, such as one described in Japanese Patent Laid-Open No. 2004-347761, for example, can be used.

The information processing apparatus 120 further includes an occurrence-frequency acquiring unit 210, a prosodic feature deriving unit 212, and a prosodic fluctuation analyzing unit 214. The prosodic feature deriving unit 212 extracts the same words and phrases that are surrounded by pauses from speech data acquired by the sound analyzing unit 208, applies sound analysis again to each of the words and phrases to derive phoneme duration(s), fundamental frequency (f0), power (p), and MFCC (c) for the word of interest, generates a prosodic feature vector which is vector data containing prosodic feature values representing elements from the word or phrase, characterizes the word, and passes the word and prosodic feature vector to the prosodic fluctuation analyzing unit 214 along with the mapping between the word and the prosodic feature vector.

The occurrence-frequency acquiring unit 210 numerically represents, as the number of occurrences, the frequency of occurrence of the same word or phrase, within the speech data, which are separated by pauses according to an embodiment of the present invention. The numerically represented number of occurrences is sent to the prosodic fluctuation analyzing unit 214 to determine a key phrase. For example, the mel-frequency cepstrum coefficient, 12-dimensional coefficients can be obtained for the respective dimensions of frequency. However, the present embodiment can also use the MFCC of a particular dimension or the largest MFCC for calculating the degree of fluctuation.

In another embodiment of the present invention, the prosodic fluctuation analyzing unit 214 uses the number of occurrences from the occurrence-frequency acquiring unit 210 and individual prosodic feature vectors for the same words and phrases from the prosodic feature deriving unit 212 for (1) identifying words and phrases whose number of occurrences is at or above an established threshold, (2) calculating a variance of each element of the respective prosodic feature vectors for the words and phrases identified, and (3) numerically representing the degree of fluctuation of prosody for words and phrases with a high frequency of occurrence, such as an occurrence which meets a certain threshold, included in the speech data as a degree of dispersion from the variance of each element calculated, and determining a key phrase that characterizes the topic in the speech data from the words and phrases with a high frequency of occurrence according to the magnitude of fluctuation. The information processing apparatus 120 can also include a topic identifying unit 218 as shown in FIG. 2.

In other embodiments, the topic identifying unit 218 can further extract contents of an utterance of the caller 110 that is in synchronization with and temporally precedes the time at which a key phrase determined by the prosodic fluctuation analyzing unit 214 occurs in speech data as a topic and acquire text representing the topic so that a semantic analyzing unit (not shown), for example, of the information processing apparatus 120 can analyze and evaluate the contents of the speech data. A key phrase is then derived from speech data for the employee 112 using sound analysis.

The information processing apparatus 120 can also include input/output devices including a display device, a keyboard and a mouse to enable operation and control of the information processing apparatus 120, allowing control on start and end of various processes and display of results on the display device.

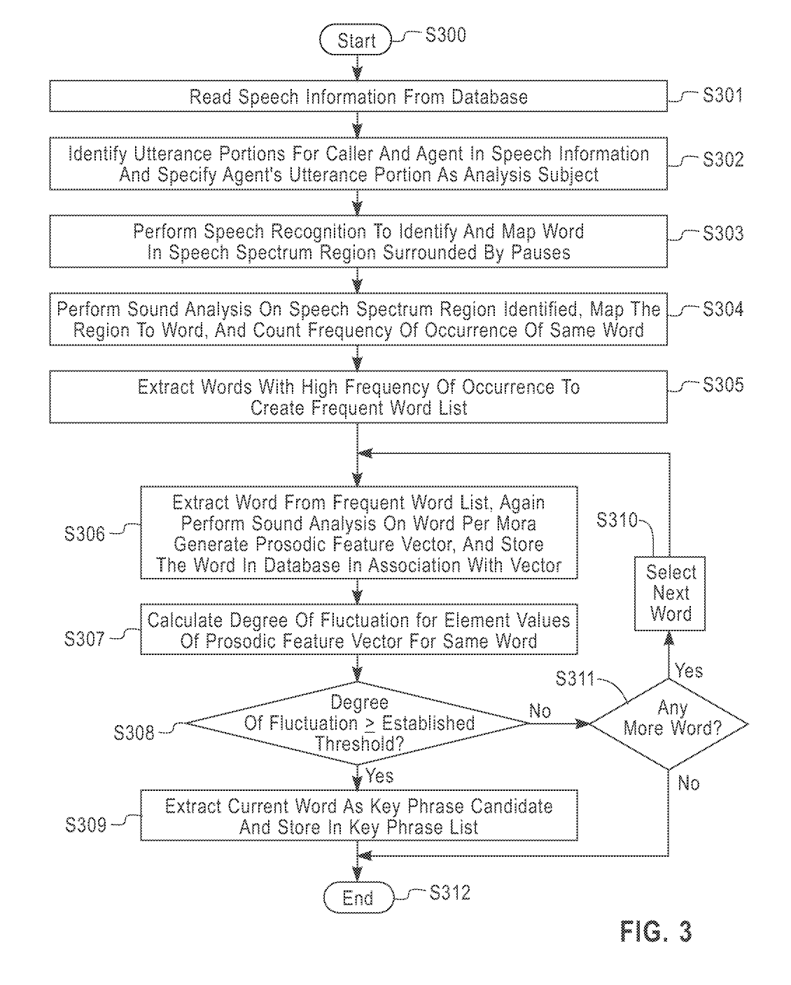

FIG. 3 shows a flowchart generally showing an information processing method for determining a key phrase according to an embodiment of the present invention. The process of FIG. 3 starts at step S300. At step S301, speech data is read from the database, and at step S302, part of utterance for the caller and the employee are identified in the speech data and a part of utterance of the employee is specified as an analysis subject. At step S303, speech recognition is performed in order to output a word and phrase string as the result of speech recognition. At the same time, the part of utterance of words and phrases are mapped to speech spectrum regions. At step S304, regions that correspond to the employee's utterance and that are surrounded by silence (or pauses) are identified and the number of occurrences of the same words is counted.

At step S305, words with a large number of occurrences are extracted from occurring words, and a list of frequent words is created. Extraction can employ a process for extracting words which has a frequency of occurrence exceeding a certain threshold or sorting words in descending order of the frequency of occurrence and extracting top M words (M being a positive integer), for example, without being specifically limited in the invention. At step S306, a word is taken from a candidate list and subjected to sound analysis again per mora “xⱼ” which constitutes the word, generating a prosodic feature vector. At step S307, variances of elements of the prosodic feature vector for each of the same words is calculated, and a degree of dispersion is calculated as a function of variances as many as elements, and the degree of dispersion is used as the degree of prosodic fluctuation.

In the present embodiment, the degree of fluctuation per mora B_{{mora}} can be specifically determined using Formula (1) below.

$${B}_{\{ mora \}} = {\sum }_{i} \{ {λ}_{i} {σ}_{\{ mora \} , i} \} = {λ}_{1} σ ( {s}_{\{ mora \} , i} ) + {λ}_{2} σ ( f {0}_{\{ mola \} , i} ) + {λ}_{3} σ ( {p}_{\{ mola \} , i} ) + λ σ ( {c}_{\{ mora \} , i} ) \qquad [ Formula ( 1 ) ]$$

In Formula (1), “mora” is a suffix indicating that it is the degree of fluctuation for a mora that constitutes the current word. Suffix “i” specifies the ith element of a prosodic feature vector, σᵢ is the variance of the ith element, and λᵢ is a weighting factor for making the ith element be reflected in the degree of fluctuation. The weighting factor can be normalized so that Σ(λᵢ)=1 is satisfied.

The degree of fluctuation B for the entire word or phrase is given by Formula (2):

$$Degree of Fluctuation B = {\sum }_{j} {B}_{[ mora ] , j} \qquad [ Formula ( 2 ) ]$$

In Formula (2), “j” is a suffix specifying mora xⱼ that constitutes the word or phrase. The present embodiment describes that the degree of fluctuation B in Formula (1) is given by degree of dispersion calculated as a linear function of variances. However, for a degree of dispersion that gives a degree of fluctuation B, this embodiment of the present invention can use any appropriate functions, such as sum of products, exponential sum, and linear or non-linear polynomial, as appropriate for word polysemy, attributes of a word such as whether it is an exclamation, and context of the topic to be extracted, to calculate a degree of dispersion, and employ the degree of dispersion as a measure of the degree of fluctuation B. A variance can be defined in a form suitable for a distribution function used.

In the embodiment described in FIG. 3, it is determined whether or not the degree of fluctuation is equal to or greater than the certain threshold at step S308. If the fluctuation is equal to or greater than the established threshold (yes), the current word is extracted as a key phrase candidate and placed in a key phrase list at step S309. If the degree of fluctuation is smaller than the threshold at step S308 (no), it is checked at step S311 whether or not there is a next word in the frequent word list. If there is a characteristic word (yes), the word is selected from the frequent word list at step S310 and the process at steps S306 through S309 is repeated. If it is determined at step S311 that there are no more words in the frequently occurring word list (no), the flow branches to step S312, where key phrase determination ends.

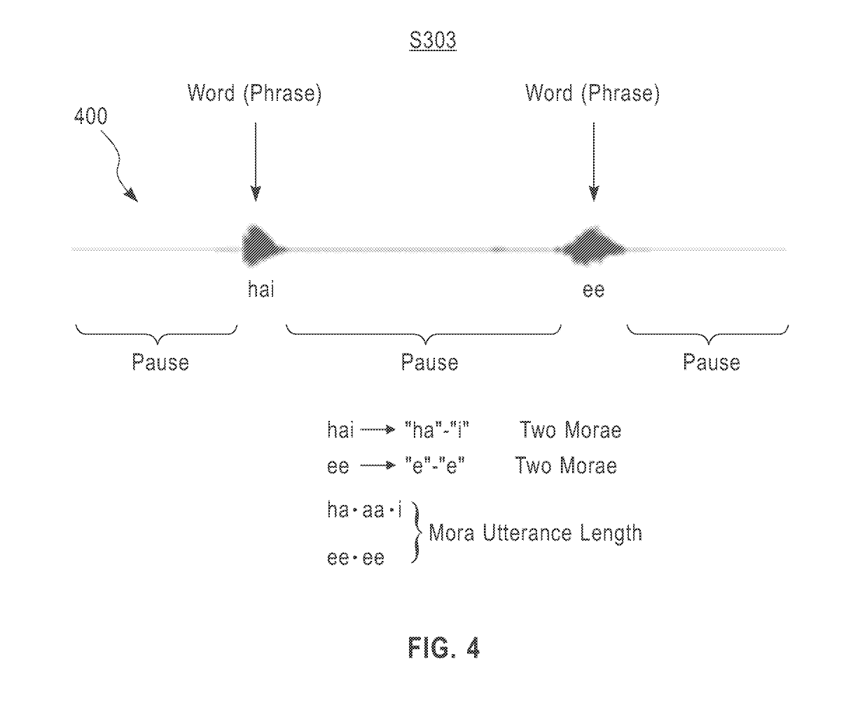

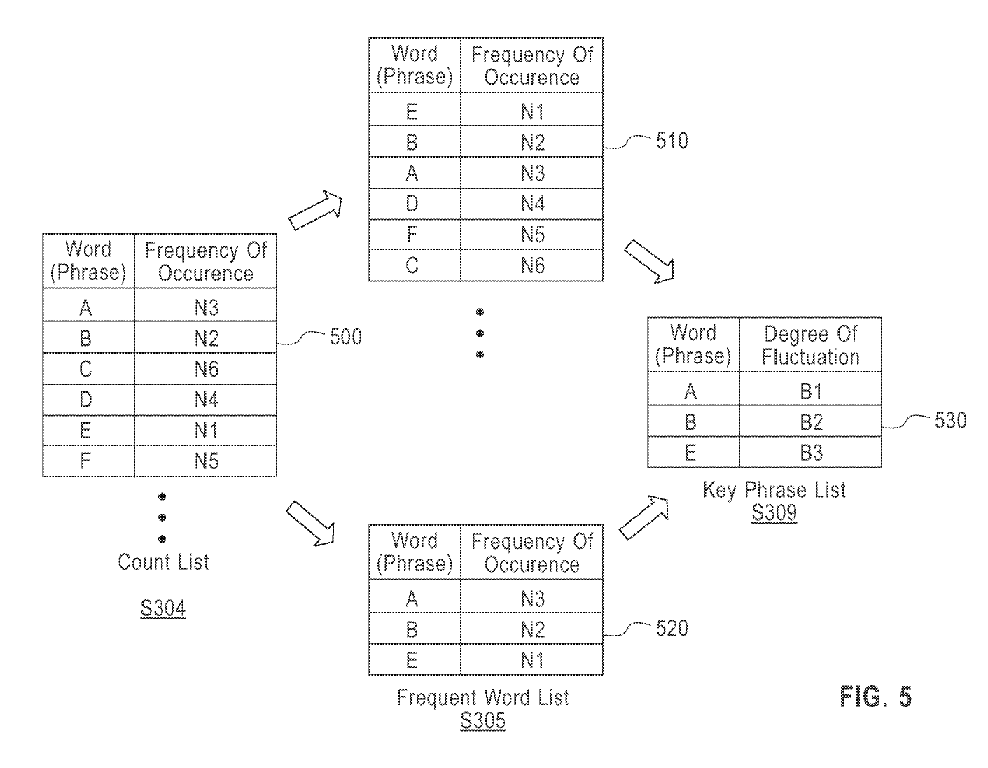

FIG. 4 conceptually illustrates a speech spectrum executed by the information processing apparatus at step S303 in the process described in FIG. 3. The speech spectrum shown in FIG. 4 is an enlarged view of the speech spectrum shown as the rectangular area 400 in FIG. 1. The speech spectrum shown in FIG. 4 represents a section in which “hai (“yes”)” and “ee (“yes”)” are recorded as words, where the left hand side of the speech spectrum corresponds to the word “hai (“yes”)” and the right hand side to the word “ee (“yes”)”. In the embodiment shown in FIG. 5, a pause (silent) has been identified before and after the words “hai (“yes”)” and “ee (“yes”)”. In the present embodiment, one of the conditions for a word to be characteristic is speech signal exceeding an S/N ratio lasting for a length of a part of utterance of the section. Thus, any section that does not satisfy the condition is identified as a pause in the present embodiment so that noise can also be eliminated.

FIG. 5 shows an embodiment of various lists generated at steps S304, S305 and S309 in the present embodiment. Upon identifying the same word in a speech, the occurrence-frequency acquiring unit 210 increments the number of occurrences to generate a count list 500, for example. The left column of the list 500 shows words or phrases identified, and the right column counts the number of occurrences like N1 to N6. The count values in FIG. 5 are assumed to be in the order of magnitude N1>N2>N3 . . . >N6 for the sake of description.

At step S305, a frequent word list 510 or 520 is generated by extracting words having the number of occurrences equal to or greater than a threshold from words stored in the count list 500 or sorting the words in the list 500 according to the number of occurrences. The frequently occurring word list 510 represents an embodiment that uses sorting to generate the list and the frequently occurring word list 520 represents an embodiment that extracts words above a threshold to generate the list. Then, at step S309, words and phrases are extracted from the frequently occurring word list 510 or 520 according to whether the degree of fluctuation B is equal to or greater than an established value or not, and a key phrase list 530 is generated with degrees of fluctuations B1 to B3 associated with words.

It is assumed that the degrees of fluctuations B1 to B3 in the key phrase list 530 are in the order B1>B2>B3 for the purpose of description. In the present embodiment, it is preferable to use only key phrase “A” with the highest degree of fluctuation for detection of a topic because it enables temporal indexing of a topic that caused a change in emotion. It is however also possible to use all key phrases stored in the key phrase list 530 to index speech data for the purpose of analyzing more detailed context of speech data.

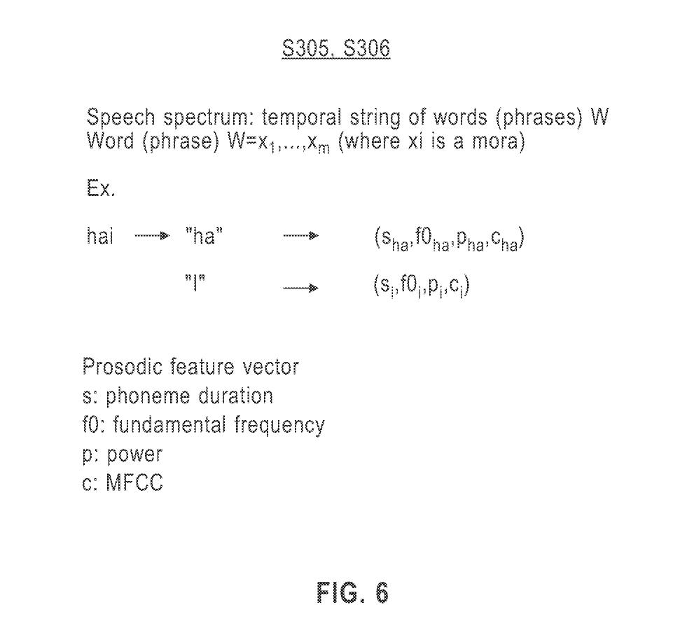

Referring to FIG. 6, an embodiment of a prosodic feature vector generated in the present embodiment will be described using the word “hai (“yes”)” as an example. The word “hai (“yes”)” consists of two morae “ha” and “i”, and a prosodic feature vector is generated per mora in the present embodiment. In the present embodiment, ‘sokuon’ or ‘cho-on’ as a mora phoneme is recognized as a difference in phoneme duration belonging to the preceding mora. Elements of a prosodic feature vector include phoneme duration (s), fundamental frequency (f0), power (p), and MFCC (c), which are determined from a speech spectrum. A feature vector corresponding to “ha” is labeled as “ha” for indicating that they correspond to the mora “ha”. A feature vector corresponding to mora “i” is also labeled as “i”.

The present embodiment calculates variance σ_{{mora}i} (1≦i≦4 in the embodiment being described) of s, f0, p, and c included in a prosodic feature vector for each same word occurring in the speech spectrum. By summing the elements, the degree of mora fluctuation B_{{mora}} is calculated, and by summing degrees of mora fluctuation for morae constituting a word or phrase, the degree of fluctuation of the word is calculated.

The present embodiment enables extraction of characteristic words in accordance with the speaker, such as an employee, allowing efficient extraction of key phrases reflecting a subtle change in mental attitude that cannot be identified from text alone, including a result of speech recognition. Thus, a topic that had a psychological influence on the speaker within a speech spectrum can be efficiently indexed.

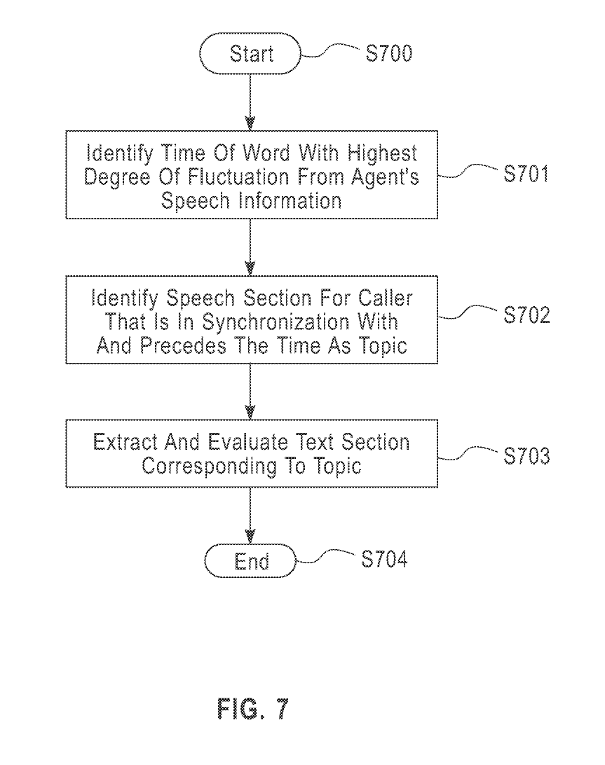

FIG. 7 is a flowchart generally showing a process of identifying a topic that had a psychological influence on the speaker, or the employee in the embodiment being described, using key phrases determined by the invention as indices within a speech spectrum. The process shown in FIG. 7 starts at step S700. At step S701, the time at which a word with the highest degree of fluctuation occurs is identified in speech data for the employee. At step S702, a particular time section or a part of utterance in speech data for the caller that is in synchronization with and temporally precedes the time is identified as the topic. At step S703, a text section corresponding to speech data representing the topic is identified or extracted from already prepared text data and evaluated. At step S704, the process ends.

The process of FIG. 7 enables utilization of a key phrase obtained by the present embodiment for indexing a portion of speech data that had a psychological influence on the speaker. It also permits more efficient speech analysis concerning non-verbal or paralinguistic information on speech data representing conversation or the like by enabling information on a portion of interest to be acquired rapidly and with low overhead without having to search the entire speech data. Also, numerical representation of the degree of fluctuation per mora for a particular word or phrase enables prosodic change of the word or phrase to be mapped to paralinguistic information. The present invention is thus also applicable to an emotion analysis method and apparatus for analyzing psychological transition of speakers who are at remote locations and do not meet face-to-face, such as in a telephone conversation or conference, for example. The present invention is described in more detail below with specific examples.

### EXAMPLE 1

A program for carrying out the method for the present embodiment was implemented in a computer and key phrase analysis was conducted on each piece of conversation data using 953 pieces of speech data on conversations held over telephone lines as samples. The length of conversation data was about 40 minutes at maximum. For determination of a key phrase, λ₁=1 and λ₂ to λ₄=0, namely phoneme duration, were used as a feature element in Formula (1), and words or phrases whose degree of fluctuation B satisfies B≧6 were extracted as key phrases with the frequency occurrence threshold of 10. In sound analysis, length of a frame was 10 ms and a MFCC was calculated. Statistic analysis of all calls yielded words (phrases) “hai (“yes”)” (26,638), “ee (“yes”)” (10,407), “un (“yeah”)” (7,497), and “sodesune (“well”)” (2,507) in descending order, where the values in parentheses indicate the number of occurrences.

Top six words (or phrases) with large variations in phoneme duration were also extracted from the 953 pieces of speech data. As a result, “un (“yeah”)” was the word with the highest degree of fluctuation in 122 samples, “ee (“yes”)” was the word with the highest degree of fluctuation in 81 samples, “hai (“yes”)” was the word with the highest degree of fluctuation in 76 samples, and “aa (“yeah”)” was the word with the highest degree of fluctuation in 8 samples, in descending order of the degree of fluctuation. The following words with the highest degree of fluctuation were “sodesune (“well”)” (7 samples) and “hee (“oh”)” (3 samples). These results show that the present embodiment extracts words and phrases as key phrases in an order different from the order based on statistic frequency occurrence with words (phrases) occurring in speech data as the population. The result of Example 1 is summarized in Table 1.

TABLE 1

| Ranking | Population | Example 1 |
|---|---|---|
| 1 | hai | un |
| 2 | ee | ee |
| 3 | un | hai |
| 4 | sodesune | aa |

### EXAMPLE 2

In order to study relevance between the degree of fluctuation in speech data and key phrases, about fifteen-minute voice calls were analyzed according to the invention using the program mentioned in Example 1 to calculate degree of fluctuation. The result is shown in Table 2.

TABLE 2

| Word (or phrase) | Frequency of occurrence | Degree of fluctuation |
|---|---|---|
| hai | 137 | 6.495 |
| un | 113 | 12.328 |
| aa | 39 | 14.445 |
| hee | 24 | 22.918 |

As shown in Table 2, the word “hai (“yes”)” occurred most frequently in the voice calls used in Example 2. However, independently from the frequency of occurrence, “hee (“oh”)” was the word with the highest degree of fluctuation. Words reflecting particular non-verbal or paralinguistic information also differ from one speaker to another, reflecting the personality of the employee who generated the voice calls used in Example 2 and/or contents of the topic. The result from the sample calls used showed that the present invention can extract a word that prosodically fluctuates most in accordance with the personality of the employee without specifying a particular word in speech data.

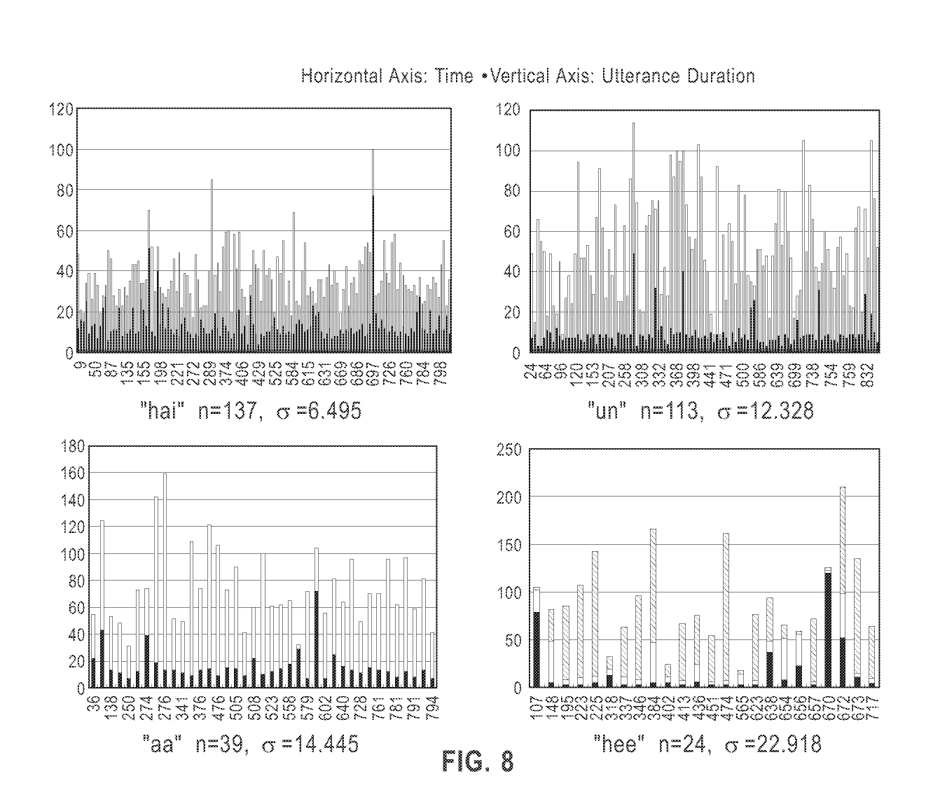

Further, FIG. 8 shows a graph plotting phoneme duration of morae constituting words used for calculation of degree of fluctuation in order to study details of prosodic variations, where the horizontal axis represents time of occurrence in speech data and the vertical axis represents mora phoneme duration. FIG. 8 also shows words and the degree of fluctuation of those words. Difference in density of cumulative bar charts for mora duration from the word “hai (“yes”)” to “hee (“oh”)” comes from variation in the number of occurrences. Also, as for the word “hee (“oh”)” extracted as a key phrase in this example, it was found out that a cho-on added after the original mora “e” out of the two morae “he” and “e” produces a phoneme corresponding to the cho-on “extended vowel” unlike the other words, and a significant variation in length of this additional cho-on characteristically increases the degree of fluctuation.

The result of Example 2 proved that the method for the invention can extracts key phrases with high accuracy.

### EXAMPLE 3

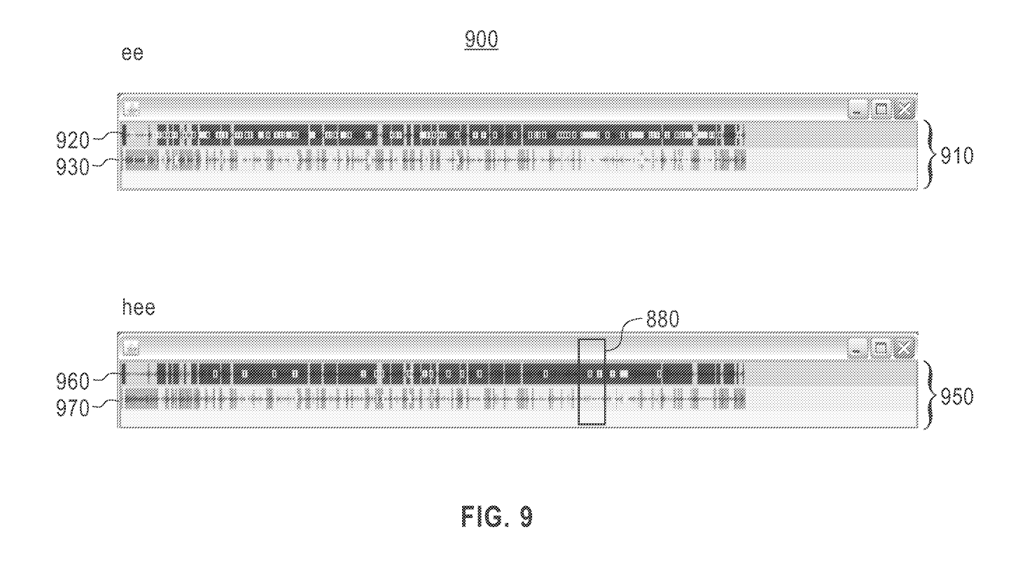

Example 3 studied indexing of speech data using key phrases. FIG. 9 shows the result of indexing speech data for the employee with words “ee (“yes”)” and “hee (“oh”)” and extracting speech data for the caller assuming that fifteen seconds preceding those words represents a topic by the caller, in the speech data used in Example 2. In FIG. 9, speech data 910 and 950 represent the result of temporal indexing with the words “ee (“yes”)” and “hee (“oh”)”, respectively. Also, speech data 920 and 960 are for the caller and speech data 930 and 970 are for the employee.

As shown in FIG. 9, it wad found out that in temporal indexing using “hee (“oh”)”, which is a key phrase extracted by the invention, regions in the caller's speech data can be significantly reduced in response to a low frequency of occurrence of the key phrase “hee (“oh”)”. For example, when the word “ee (“yes”)”, which is not a key phrase, was used to extract a corresponding topic, it was necessary to extract about 51.6% of information in the caller's speech data 920. On the other hand, use of a key phrase extracted by the invention can extract all topics by extracting only about 13.1% of the caller's speech data 960. These facts proved that the invention can efficiently extract topics relating to non-verbal or paralinguistic information of interest from all speech data.

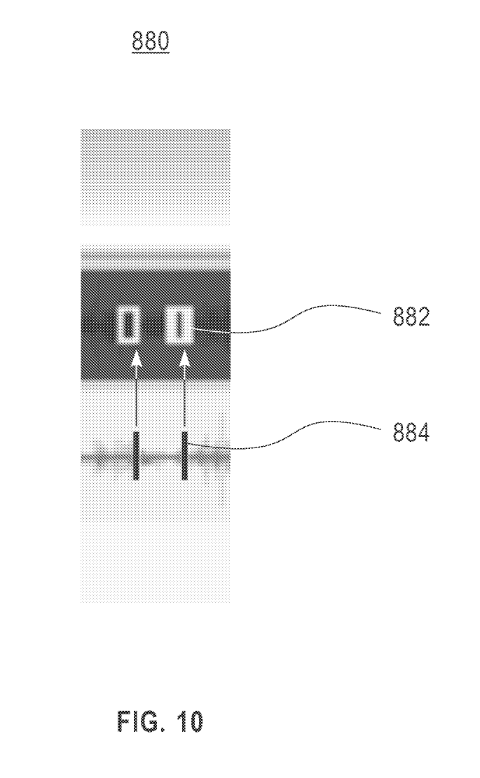

FIG. 10 is an enlarged view of a box 880 shown in FIG. 9. As shown in FIG. 10, a time 884 at which a key phrase is uttered and the end of a topic 882 by the utterer are well mapped to each other, showing that a key phrase determined by the invention can effectively index a topic spoken about by the caller.

As described above, the an embodiment of the present invention can provide an information processing apparatus, information processing method, information processing system, and a program capable of extracting a key phrase or phrase that characteristically reflects non-verbal or paralinguistic information not verbally explicit, such as bottled-up anger or small gratification, and that is probably most efficient for extracting a change in the speaker's mental attitude without being affected by the speaker's habitual expression, in addition to words that allow an emotion to be identified, such as an outburst of anger (e.g., yelling “Call your boss!”).

The embodiment of the present invention identifies a temporally indexed key phrase to enable efficient conversation analysis as well as efficient and automated classification of emotions or mental attitudes of speakers who do not meet face-to-face, without involving redundant search in the entire speech data region.

The above-described functionality of the invention can be provided by a machine-executable program written in an object-oriented programming language, such as C++, Java®, Javabeans®, Javascript®, Perl, Ruby, and Python, or a search-specific language such as SQL, and distributed being stored in a machine-readable recording medium or by transmission.

1. An information processing apparatus for acquiring, from speech data of a recorded conversation, a key phrase identifying information that is not expressed verbally in the speech data, the apparatus comprising:
a database comprising (i) the speech data of the recorded conversation and (ii) sound data used for recognizing phonemes, within the speech data, as at least one word;
a sound analyzing unit configured to (i) perform sound analysis on the speech data using the sound data and (ii) assign the at least one word to the speech data;
a prosodic feature deriving unit configured to (i) identify a section surrounded by pauses within a speech spectrum of the speech data and (ii) perform sound analysis on the identified section, wherein (i) said sound analysis generates at least one prosodic feature value for an identified word in the identified section and (ii) the prosodic feature value is an element of the identified word;
an occurrence-frequency acquiring unit configured to acquire at least one frequency of occurrence of each of the at least one word assigned by the sound analyzing unit within the speech data; and
a prosodic fluctuation analyzing unit configured to calculate a degree of fluctuation within the speech data for the prosodic feature values of at least one high frequency word, and determine a key phrase based on the degree of fluctuation wherein the at least one high frequency word comprises any word from the at least one word whose frequency of occurrence meets a threshold.

2. The information processing apparatus according to claim 1, further comprising a topic identifying unit configured to categorize the speech data as (i) speech data including a topic and/or (ii) speech data including a key phrase for each speaker, determine a time at which the key phrase occurs in the speech data, and identify a speech section that has been recorded in synchronization with and ahead of the key phrase as a topic.

3. The information processing apparatus according to claim 1, wherein the prosodic feature deriving unit characterizes prosody with one or more prosodic feature values for the at least one word, wherein the prosodic feature values are selected from a group consisting of a phoneme duration, a phoneme power, a phoneme fundamental frequency, and a mel-frequency cepstrum coefficient.

4. The information processing apparatus according to claim 1, wherein the prosodic fluctuation analyzing unit is further configured to calculate a variance of each element of the at least one prosodic feature value for the at least one high frequency word, and determine the key phrase according to magnitude of the variance.

5. The information processing apparatus according to claim 1, further comprising a speech data acquiring unit configured to acquire over the network speech data resulting from talking on a fixed-line telephone over (i) a public telephone network or (ii) an IP telephone network such that speakers are identifiable.

6. The information processing apparatus according to claim 1, further comprising a topic identifying unit configured to identify the speech data for each speaker, determine a time at which the key phrase occurs in the speech data, and identify a speech section that has been recorded in synchronization with and ahead of the key phrase as a topic, wherein text data corresponding to the identified speech section is retrieved and contents of the topic are analyzed and evaluated.

7. An information processing method for acquiring, from speech data of a recorded conversation, a key phrase identifying information that is not expressed verbally in the speech data, the information processing method comprising the steps of:
extracting, from a database, speech data of the recorded conversation and sound data used for recognizing phonemes included in the speech data as words;
identifying a section surrounded by pauses within a speech spectrum of the speech data;
performing sound analysis on the identified section to identify at least one word in the section;
generating at least one prosodic feature value for the at least one word wherein the at least one prosodic feature value of the at least one word is an element of the at least one word;
acquiring a frequency of occurrence of the at least one word within the speech data;
calculating a degree of fluctuation within the speech data for the prosodic feature value of at least one high frequency word wherein the at least one high frequency word comprises any word from the at least one word whose frequency of occurrence meets a threshold; and
determining a key phrase based on the degree of fluctuation.

8. The information processing method according to claim 7, further comprising:
identifying the speech data for each speaker;
determining a time at which the key phrase occurs in the speech data; and
identifying, as a topic, a speech section that has been recorded in synchronization with and ahead of the key phrase.

9. The information processing method according to claim 7, wherein the at least one prosodic feature value is selected from a group consisting of a phoneme duration, a phoneme power, a phoneme fundamental frequency, and a mel-frequency cepstrum coefficient.

10. The information processing method according to claim 7, wherein the step of determining the key phrase comprises the steps of:
calculating a variance of each element of the at least one prosodic feature value for each of the at least one high frequency word; and
determining the key phrase according to magnitude of the variance.

11. A computer readable non-transitory storage medium tangibly embodying a computer readable program code having computer readable instructions which when implemented, cause a computer to carry out the steps of a method comprising:
extracting, from a database, speech data of the recorded conversation and sound data used for recognizing phonemes included in the speech data as words;
identifying a section surrounded by pauses within a speech spectrum of the speech data;
performing sound analysis on the identified section to identify at least one word in the section;
generating at least one prosodic feature value for the at least one word wherein the at least one prosodic feature value of the at least one word is an element of the at least one word;
acquiring a frequency of occurrence of the at least one word within the speech data;
calculating a degree of fluctuation within the speech data for the prosodic feature value of at least one high frequency word wherein the at least one high frequency word comprises any word from the at least one word whose frequency of occurrence meets a threshold; and
determining a key phrase based on the degree of fluctuation.

12. The computer readable non-transitory storage medium according to claim 11, further comprising the steps of:
identifying the speech data for each speaker;
determining a time at which the key phrase occurs in the speech data; and
identifying a speech section that has been recorded in synchronization with and ahead of the key phrase as a topic.

13. The computer readable non-transitory storage medium according to claim 11, wherein the at least one prosodic feature value is selected from a group consisting of a phoneme duration, a phoneme power, a phoneme fundamental frequency, and a mel-frequency cepstrum coefficient.

14. The computer readable non-transitory storage medium according to claim 11, further comprising the steps of:
calculating a variance of each element of the at least one prosodic feature value for each of the at least one high frequency word; and
determining the key phrase according to magnitude of the variance.
